(19) United States
(12) Patent Application Publication
(10) Pub. No.: US 2010/0321359 A1
(43) Pub. Date: Dec. 23, 2010

(54) COMMON VOLTAGE GENERATING CIRCUIT OF AN LCD

(76) Inventors: Yu-An Liu, Yunlin County (TW); Tien-Chu Hsu, Kaohsiung City (TW); Shu-Yang Lin, Yunlin County (TW)

Correspondence Address: NORTH AMERICA INTELLECTUAL PROPERTY CORPORATION, P.O. BOX 506, MERRIFIELD, VA, 22116, US

(21) Appl. No.: 12/536,512

(22) Filed: Aug. 6, 2009

(30) Foreign Application Priority Data
Jun. 22, 2009 (TW) 098120831

(51) Int. Cl. G09G 3/36; G09G 5/00

(52) U.S. Cl. 345/209; 345/208

(57) ABSTRACT

A common voltage generating circuit of an LCD includes a first flip-flop, a capacitor, a resistor and a regulating circuit. The first flip-flop receives a data-loading signal from the LCD, for outputting a step signal. The step signal forms a waveform voltage through the capacitor and the resistor. The regulating circuit inverts the waveform voltage and adjusts the magnitude and the DC level of the waveform voltage, for generating a common voltage. Compare to the common voltage of the color filter base plate, the common voltage generated by the common voltage generating circuit have the same frequency and magnitude, but opposite direction. Therefore, by generating the common voltage of opposite direction, the present invention eliminates crosstalk and improves uneven brightness of the displayed image.

### BACKGROUND OF THE INVENTION

1. Field of the Invention

The present invention relates to a common voltage generating circuit, and more particularly, to a common voltage generating circuit for eliminating the crosstalk.

2. Description of the Prior Art

Please refer to FIG. 1. FIG. 1 is a diagram illustrating a conventional Liquid Crystal Display (LCD). The LCD includes a Thin Film Transistor (TFT) base plate 101. The TFT base plate 101 includes a gate-driving circuit 110 and a data-driving circuit 120. The gate-driving circuit 110 includes a plurality of gate lines G₁˜G_{N} for generating gate-driving signals S_{G1}˜S_{GN} sequentially. The data-driving circuit 120 includes a plurality of data lines D₁˜D_{M} for generating data-driving signals S_{D1}˜S_{DM}. The gate lines G₁˜G_{N} are parallel with each other, and the data lines D₁˜D_{M} are parallel with each other. As shown in FIG. 1, the locations at the crossing of each data line D₁˜D_{M} and each gate line G₁˜G_{N} are coupled to a TFT transistors, respectively. Each TFT transistor P is corresponding to a pixel, and the TFT transistors P are distributed as a matrix on the LCD. Furthermore, each pixel is driven by the gate-driving signal generated by the corresponding gate line for receiving the data-driving signal generated by the corresponding data line. In simple words, the data-driving circuit 120 and the gate driving circuit 110 control turning on the TFT transistors P for displaying image.

The LCD further includes a Color Filter (CF) (not shown in the figure) parallel with the TFT base plate 101. The common electrode of the CF can be treated as a resistor-capacitor network. Please refer to FIG. 2. FIG. 2 is a diagram illustrating a common voltage of the common electrode of the CF shifting the voltage level because of the capacitor-coupling effect of the data lines. As shown in FIG. 2, when the voltages on the data lines of the TFT base plate 101 are varying, the common voltage V_{COM}_{_{—}}_{CF} of the CF shifts from the original DC level because of the capacitor-coupling effect of the data lines. Thus, the charging voltage level of the liquid capacitors are different so that the brightness of the displayed image are uneven, which is referred to as the crosstalk phenomenon.

The crosstalk refers the phenomenon that an area of the displayed image affects the brightness of the neighboring area. Moreover, when the following conditions are all tenable, the LCD generates the crosstalk phenomenon:
1. The capacitor-coupling effect affects so much that the common voltage of the CF V_{COM}_{_{—}}_{CF} shifts from a predetermined voltage level V_{DEF};
2. The period of the common voltage of the CF V_{COM}_{_{—}}_{CF} recovering to the predetermined voltage level V_{DEF} is longer than a predetermined value;
3. The period of the common voltage of the CF V_{COM}_{_{—}}_{CF} recovering to the predetermined voltage level V_{DEF} is longer than the period that a gate line of the LCD transmitting the gate-driving signal to the pixel.

In conclusion, the common voltage of the CF V_{COM}_{_{—}}_{CF} shifts from a predetermined voltage level V_{DEF} because of the capacitor-coupling effect of the data lines. Because of the voltage-shift of the common voltage of the CF V_{COM}_{_{—}}_{CF}, the LCD generates the crosstalk phenomenon. Hence, the brightness of the displayed image are uneven, causing a great inconvenience.

### SUMMARY OF THE INVENTION

Therefore, an objective of the present invention is generating a common voltage inverted to a common voltage of a color filter of a Liquid Crystal Display (LCD) on a TFT base plate of the LCD for eliminating the crosstalk effect.

The present invention provides a common voltage generating circuit of an LCD. The common voltage generating circuit comprises a first flip-flop, a capacitor, a resistor, and a regulation circuit. The first flip-flop has a first input end, a second end, a negative clock input end, and an output end. The negative clock input end of the first flip-flop is utilized for receiving a data-loading signal of the LCD. The output end of the first flip-flop is utilized for outputting a first step signal. The capacitor has a first end, and a second end. The first end of the capacitor is electrically connected to the output end of the first flip-flop. The resistor has a first end, and a second end. The first end of the resistor is electrically connected to the second end of the capacitor for outputting a waveform voltage. The second end of the resistor is electrically connected to a ground end. The regulation circuit is electrically connected to the first end of the resistor. The regulation circuit is utilized for inverting the waveform voltage and adjusting DC level and magnitude of the waveform voltage according to a reference voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional LCD.

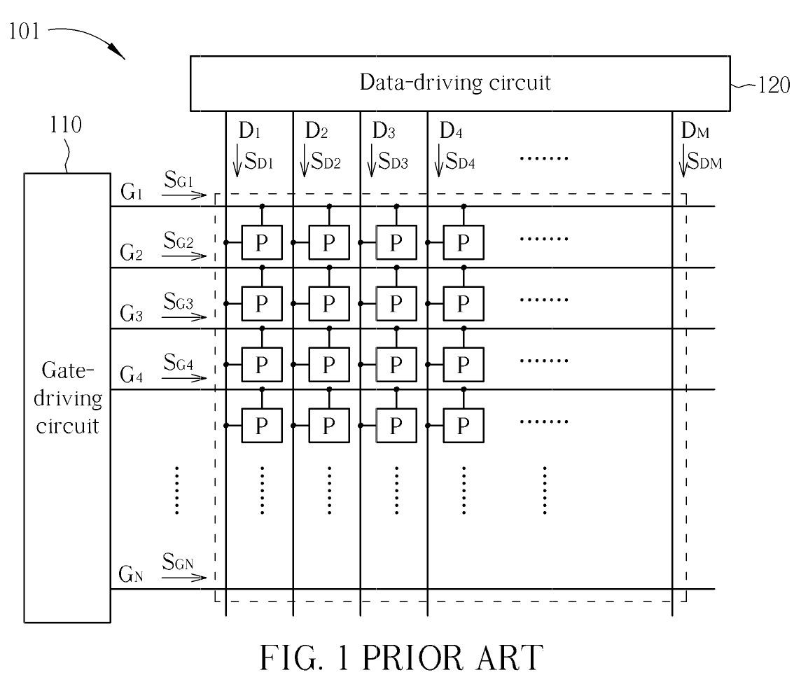

FIG. 2 is a diagram illustrating a common voltage of the common electrode of the color filter shifting the voltage level because of the capacitor-coupling effect of the data lines.

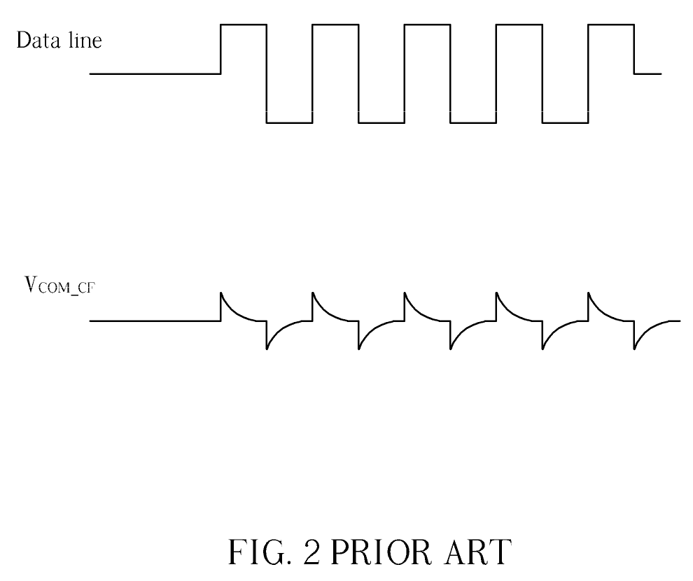

FIG. 3 is a diagram illustrating a common voltage generating circuit of the LCD according to a first embodiment of the present invention.

FIG. 4 is a schematic diagram illustrating the regulation circuit and the reference-voltage generating circuit of the present invention.

FIG. 5 is a diagram illustrating a common voltage generating circuit according to a second embodiment of the present invention.

FIG. 6 is a waveform diagram illustrating the signals of the common voltage generating circuit according the second embodiment of the present invention.

### DETAILED DESCRIPTION

In the specification and the claim of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” is to mean any electrical connection in a direct manner or an indirect manner. Therefore, the description of “a first device electrically connected to a second device” is to mean that the first device is connected to the second device directly or by means of connecting through other devices or methods in an indirect manner.

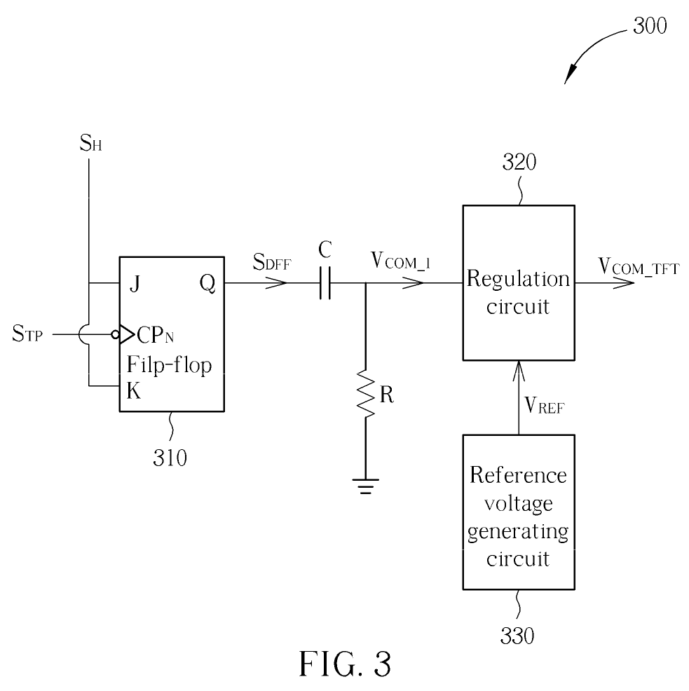

Please refer to FIG. 3. FIG. 3 is a diagram illustrating a common voltage generating circuit 300 of the LCD according to a first embodiment of the present invention. The common voltage generating circuit 300 comprises a flip-flop 310, a capacitor C, a resistor R, a regulating circuit, and a reference-voltage generating circuit 330. Since the common voltage of the CF V_{COM}_{_{—}}_{CF} of the LCD are affected by the capacitor-coupling effect of the data lines so that the data lines generate pulse when the signal polarities of the data lines reverse, the common voltage generating circuit 300 generates the common voltage of the TFT transistors V_{COM}_{_{—}}_{TFT} according to the data-loading signal S_{TP} of the LCD. The flip-flop 310 comprises a first input end J, a second input end K, a negative clock input end CP_{N}, and an output end Q. The first input end J and the second input end K are utilized for receiving a signal S_{H} of logic “1” (high voltage level). The negative clock input end CP_{N} is utilized for receiving the data-loading signal S_{TP}. The output end Q is utilized for outputting a step signal S_{DFF}. A first end of the capacitor C is electrically connected to the output end Q of the flip-flop 310. A first end of the resistor R is electrically connected to a second end of the capacitor C. A second end of the resistor R is electrically connected to a ground end. The step signal S_{DFF} passes through a high-pass circuit formed by the capacitor C and the resistor R so as to generate a waveform voltage V_{COM}_{_{—}}₁. The regulation circuit 320 is electrically connected to the first end of the resistor R and the reference-voltage generating circuit 330. The reference-voltage generating circuit 330 is utilized for generating a reference voltage V_{REF}. The regulation circuit 320 is utilized for inverting the waveform voltage V_{COM}_{_{—}}₁, and adjusting the DC level and magnitude of the waveform voltage V_{COM}_{_{—}}₁ according to the reference voltage V_{REF}, so as to generate a common voltage of the TFT transistors V_{COM}_{_{—}}_{TFT}.

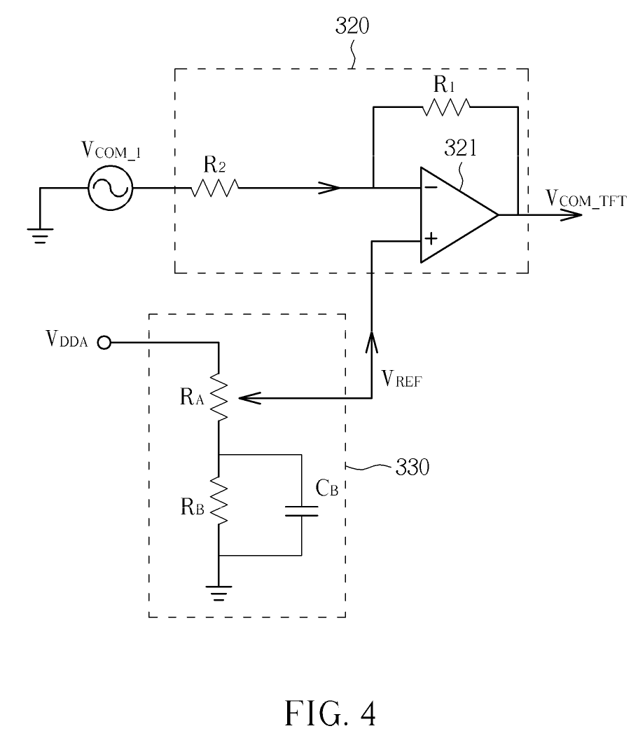

Please refer to FIG. 3 and FIG. 4. FIG. 4 is a schematic diagram illustrating the regulation circuit 320 and the reference-voltage generating circuit 330. The reference-voltage generating circuit 330 comprises a variable resistor R_{A}, a resistor R_{B} and a capacitor C_{B}. The variable resistor R_{A} comprises a first end electrically connected to a voltage source V_{DDA}, a second end, and a third end electrically connected to a positive input end of an operational amplifier 321 of the regulation circuit 320. The resistor R_{B} comprises a first end electrically connected to the second end of the variable resistor, and a second end electrically connected to the ground end. The capacitor C_{B} comprises a first end electrically connected to the first end of the resistor R_{B}, and a second end electrically connected to the second end of the resistor R_{B}. The reference-voltage generating circuit 330 generates a reference voltage V_{REF} by means of dividing the voltage of the voltage source V_{DDA}. The reference-voltage generating circuit 330 adjusts the magnitude of the reference voltage V_{REF} by means of changing the resistance of the variable resistor R_{A}. Therefore, the reference voltage V_{REF} can be adjusted to be the same as the DC level of the common voltage of the CF V_{COM}_{_{—}}_{CF}.

In addition, the regulation circuit 320 comprises an operational amplifier 321 and two resistors R₁ and R₂. The operational amplifier 321 comprises a negative input end for receiving the waveform voltage V_{COM}_{_{—}}₁ through the resistor R₂, a positive input end for receiving the reference voltage V_{REF}, and an output end for outputting the common voltage of the TFT transistors V_{COM}_{_{—}}_{TFT}. The resistor R₁ comprises a first end electrically connected to the negative input end of the operational amplifier 321, and a second end electrically connected to the output end of the operational amplifier 321. The resistor R₂ comprises a first end electrically connected to the first end of the resistor R of the common voltage generating circuit 300, and a second end electrically connected to the negative input end of the operational amplifier 321. As shown in FIG. 4, the regulation circuit 320 is a typical inverting amplifier. Since the operational principle of the inverting amplifier is well known to those skilled in the art, it will not be repeated again for brevity. The relationship between the common voltage of the TFT transistors V_{COM}_{_{—}}_{TFT} and the waveform voltage V_{COM}_{_{—}}₁ outputted by the regulation circuit 320 can be represented by the following formula:

V_{COM}_{_{—}}_{TFT}=V_{COM}_{_{—}}₁*(−R₁/R₂)

In other words, the regulation circuit 320 inverts the waveform voltage V_{COM}_{_{—}}₁ and simultaneously adjusts the magnitude of the waveform voltage V_{COM}_{_{—}}₁ by means of changing the resistance of the resistors R₁ and R₂. Hence, the common voltage of the transistors V_{COM}_{_{—}}_{TFT} outputted by the regulation circuit 320 can be adjusted to have the same magnitude and have the opposite direction of the common voltage of the CF V_{COM}_{_{—}}_{CF}.

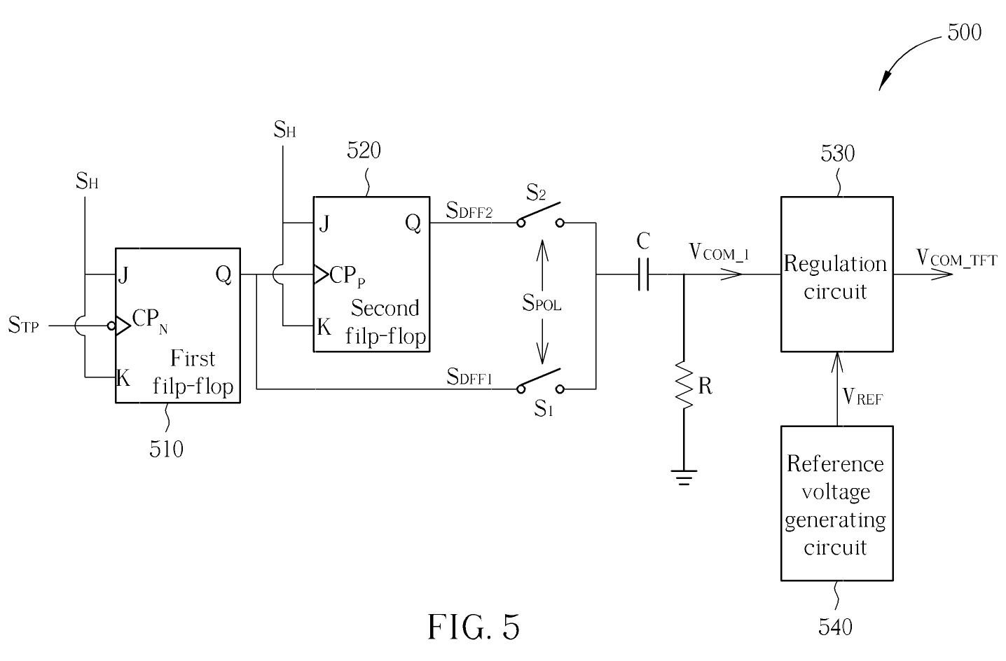

Please refer to FIG. 5. FIG. 5 is a diagram illustrating a common voltage generating circuit 500 according to a second embodiment of the present invention. The common voltage generating circuit 500 comprises a first flip-flop 510, a second flip-flop 520, a first switch S₁, a second switch S₂, a capacitor C, a resistor R, a regulation circuit 530, and a reference-voltage generating circuit 540. The first flip-flop 510 is utilized for dividing the frequency of the data-loading signal S_{TP} so as to generate a first step signal S_{DFF1}. The second flip-flop 520 is utilized for dividing the frequency of the first step signal S_{DFF1} so as to generate a second step signal S_{DFF2}. The first flip-flop 510 comprises a first input end J, a second input end K, a negative clock input end CP_{N}, and an output end Q. The second flip-flop 520 comprises a first input end J, a second input end K, a positive clock input end CP_{P}, and an output end Q. Both the first ends J and the second ends K of the first flip-flop 510 and the second flip-flop 520 are utilize for receiving the signal S_{H} of logic “1” (high voltage level). The negative clock input end CP_{N} of the first flip-flop 510 is utilized for receiving the data-loading signal S_{TP}. The output end Q of the first flip-flop 510 is utilized for outputting the first step signal S_{DFF1}. The positive clock input end CP_{P} of the second flip-flop 520 is utilized for receiving the first step signal S_{DFF1}, and the output end Q of the second flip-flop 520 is utilized for outputting the second step signal S_{DFF2}. The first switch S₁ is electrically connected between the output end Q of the first flip-flop 510 and a first end of the capacitor C. The second switch S₂ is electrically connected between the output end Q of the second flip-flop 520 and the first end of the capacitor C. In the second embodiment, the common voltage generating circuit 500 can be utilized when the data lines are operated in one-line inversion mode or in two-line inversion mode. The first switch S₁ and the second switch S₂ are controlled according to a polarity control signal S_{POL}. When the polarity control signal S_{POL} is one-line inversion, the first switch S₁ is turned on and the second switch S₂ is turned off; when the polarity control signal S_{POL} is two-line inversion, the second switch S₂ is turned on and the first switch S₁ is turned off. In other words, when the polarity control signal S_{POL} is one-line inversion, the first step signal S_{DFF1} are transmitted to the first end of the capacitor C through the first switch S₁; when the polarity control signal S_{POL} is two-line inversion, the second step signal S_{DFF2} are transmitted to the first end of the capacitor C through the second switch S₂. The structures of the capacitor C, the resistor R, the regulation circuit 530, and the reference-voltage generating circuit 540 are similar to the above-mentioned description, thus will not be repeated again for brevity. The first step signal S_{DFF1} or the second step signal S_{DFF2} passes through the high-pass filter formed by the capacitor C and the resistor R so as to generate the waveform voltage V_{COM}_{_{—}}₁. The frequency and the polarity of the waveform voltage V_{COM}_{_{—}}₁ are the same as the common voltage of the CF V_{COM}_{_{—}}_{CF}. The regulation circuit 530 is utilized for inverting the waveform voltage V_{COM}_{_{—}}₁ and adjusting the DC level and the magnitude of the waveform voltage V_{COM}_{_{—}}₁ according to the reference voltage V_{REF}, so as to generate a common voltage of the transistors V_{COM}_{_{—}}_{TFT}. Hence, the frequency and the magnitude of the common voltage of the transistors V_{COM}_{_{—}}_{TFT} are the same as the common voltage of the CF V_{COM}_{_{—}}_{CF}, but the direction of the common voltage of the TFT transistors V_{COM}_{_{—}}_{TFT} is opposite to the common voltage of the CF V_{COM}_{_{—}}_{CF}.

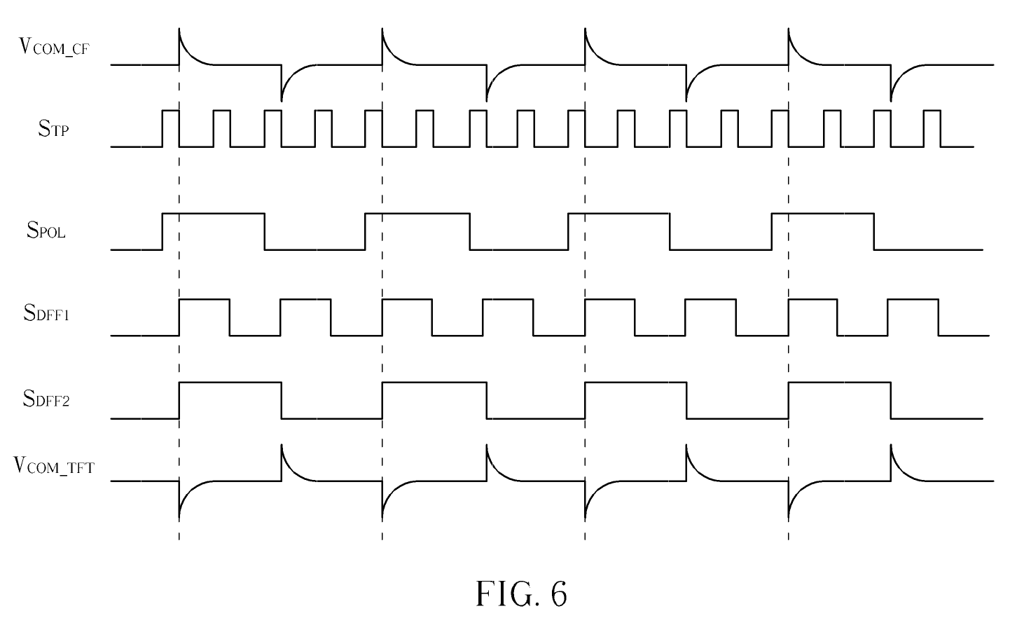

Please refer to FIG. 5 and FIG. 6. FIG. 6 is a waveform diagram illustrating the signals of the common voltage generating circuit 500. Since the common voltage of the CF V_{COM}_{_{—}}_{CF} is affected by the capacitor-coupling effect of the data lines of the TFT base plate, the common voltage of the CF V_{COM}_{_{—}}_{CF} generates pulse when the polarity of the data lines are reversed and the polarity-inversion mode of the data lines affects the pulse-frequency of the common voltage of the CF V_{COM}_{_{—}}_{CF}. As a result, the common voltage generating circuit 500 generates the common voltage of the TFT transistors V_{COM}_{_{—}}_{TFT} according to the data-loading signal S_{TP}. When the polarity-inversion mode of the data lines is one-line inversion, the data-loading signal is inputted to the first flip-flop 510 through the negative clock input end CP_{N}, and the first flip-flop 510 generates the first step signal S_{DFF1} according the falling edge of the data-loading signal S_{TP}. When the polarity-inversion mode of the data lines is two-line inversion, the data-loading signal is inputted to the second flip-flop 520 through the positive clock input end CP_{P}, and the second flip-flop 520 generates the second step signal S_{DFF2} according the rising edge of the first step signal S_{DFF1}. As shown in FIG. 6, the polarity control signal S_{POL} is two-inversion. Consequently, the second switch is turned on so that the second step signal S_{DFF2} is transmitted to the first end of the capacitor C. The second step signal S_{DFF2} passes through the high-pass filter formed by the capacitor C and the resistor R so as to generate the waveform voltage V_{COM}_{_{—}}₁. The pulse of the waveform voltage V_{COM}_{_{—}}₁ has the same frequency and the same direction as the common voltage of the CF V_{COM}_{_{—}}_{CF}. The regulation circuit 530 inverts the waveform voltage V_{COM}_{_{—}}₁, and adjusts the DC level and the magnitude of common voltage V_{COM}_{_{—}}₁ to be the same as the common voltage of the CF V_{COM}_{_{—}}_{CF}. Therefore, the voltage V_{COM}_{_{—}}₁ has the same DC level and the same magnitude as the common voltage of the CF V_{COM}_{_{—}}_{CF}, but has the opposite direction to the common voltage of the CF V_{COM}_{_{—}}_{CF}.

In the prior art, the common voltage of the CF V_{COM}_{_{—}}_{CF} is affected by the capacitor-coupling effect of the data lines of the TFT base plate, so the common voltage of the CF V_{COM}_{_{—}}_{CF} shifts from the original DC level. Since the common voltage of the CF V_{COM}_{_{—}}_{CF} shifts from the original DC level, the charging voltage levels of the liquid capacitors are different so that the brightness of the displayed image are uneven, generating the crosstalk phenomenon. In the situation, a common voltage of the transistors V_{COM}_{_{—}}_{TFT}, having the same frequency and the same magnitude as the common voltage of the CF V_{COM}_{_{—}}_{CF}, but having the opposite direction to the common voltage of the CF V_{COM}_{_{—}}_{CF}, can be generated by the common voltage generating circuit 500 of the present invention, for eliminating crosstalk.

In conclusion, the present invention provides a common voltage generating circuit of an LCD for eliminating the crosstalk. The common voltage generating circuit comprises a first flip-flop, a capacitor, a resistor, and a regulation circuit. The first flip-flop is utilized for receiving a data-loading signal of the LCD so as to output a step signal. The step signal passes through the capacitor and the resistor so as to form a waveform voltage. The regulation circuit inverts the waveform voltage and adjusts the DC level and the magnitude of the waveform voltage for outputting a common voltage. Compared with the common voltage of the CF, the common voltage generated by the common voltage generating circuit has the same frequency and magnitude, but opposite direction. Therefore, by generating the common voltage of opposite direction, the present invention eliminates crosstalk and improves uneven brightness of the displayed image.

Those skilled in the art will readily observe that numerous modifications and alterations of the device and method may be made while retaining the teachings of the invention.

What is claimed is:

1. A common voltage generating circuit of a Liquid Crystal Display (LCD), comprising:
a first flip-flop, having a first input end, a second input end, a negative clock input end for receiving a data-loading signal of the LCD, and an output end for outputting a first step signal;
a capacitor, having a first end electrically connected to the output end of the first flip-flop, and a second end;
a resistor, having a first end electrically connected to the second end of the capacitor for outputting a waveform voltage, and a second end electrically connected to a ground end; and
a regulation circuit, electrically connected to the first end of the resistor, for inverting the waveform voltage and adjusting DC level and magnitude of the waveform voltage according to a reference voltage.

2. The common voltage generating circuit of the LCD of claim 1, wherein the regulation circuit comprises:
an operational amplifier, having a negative input end, a positive input end for receiving the reference voltage, and an output end;
a first resistor, having a first end electrically connected to the negative input end of the operational amplifier, and a second end electrically connected to the output end of the operational amplifier; and
a second resistor, having a first end electrically connected to the first end of the resistor, and a second end electrically connected to the negative input end of the operational amplifier.

3. The common voltage generating circuit of the LCD of claim 2, further comprising a reference-voltage generating circuit for generating the reference voltage, the reference-voltage generating circuit comprising:
a variable resistor, having a first end electrically connected to a voltage source, a second end, and a third end electrically connected to the positive input end of the operational amplifier;
a resistor, having a first end electrically connected to the second end of the variable resistor, and a second end electrically connected to the ground end; and
a capacitor, having a first end electrically connected to the first end of the resistor, and a second end electrically connected to the second end of the resistor.

4. The common voltage generating circuit of the LCD of claim 1, wherein the first input end of the first flip-flop and the second input end of the first flip-flop receive a high-level voltage, respectively.

5. The common voltage generating circuit of the LCD of claim 1, further comprising:
a second flip-flop, having a first input end, a second input end, a positive clock input end for receiving the first step signal, and an output end for outputting a second step signal.

6. The common voltage generating circuit of the LCD of claim 5, wherein the first input end of the second flip-flop and the second input end of the second flip-flop receives a high-level voltage, respectively.

7. The common voltage generating circuit of the LCD of claim 5, further comprising:
a first switch, electrically connected between the output end of the first flip-flop and the first end of the capacitor; and
a second switch, electrically connected between the output end of the second flip-flop and the first end of the capacitor.

8. The common voltage generating circuit of the LCD of claim 7, wherein the first switch and the second switch are controlled according to a polarity control signal of the LCD.

9. The common voltage generating circuit of the LCD of claim 8, wherein when the polarity control signal is one-line inversion, the first switch is turned on and the second switch is turned off so as to transmit the first step signal to the first end of the capacitor.

10. The common voltage generating circuit of the LCD of claim 8, wherein when the polarity control signal is two-line inversion, the first switch is turned off and the second switch is turned on so as to transmit the second step signal to the first end of the capacitor.
